(19) United States
(12) Patent Application Publication
(10) Pub. No.: US 2015/0121298 A1
(43) Pub. Date: Apr. 30, 2015

(54) MULTI-TOUCH NAVIGATION OF MULTIDIMENSIONAL OBJECT HIERARCHIES

(71) Applicant: Evernote Corporation, Redwood City, CA (US)

(72) Inventor: Helen Asuka Ma, Cupertino, CA (US)

(21) Appl. No.: 14/529,284

(22) Filed: Oct. 31, 2014

Related U.S. Application Data
(60) Provisional application No. 61/897,908, filed on Oct. 31, 2013.

(51) Int. Cl. G06F 3/0488; G06F 3/0485; G06F 3/0481; G06F 3/0482

(52) U.S. Cl. CPC G06F 3/0488; G06F 3/0482; G06F 3/0485; G06F 3/04817
USPC 715/784; 715/810

(57) ABSTRACT

Accessing objects on a multi-touch screen includes presenting, on the multi-touch screen, a first set of items corresponding to a subset of the objects that is less than all of the objects, where the multi-touch screen has a first direction and has a second direction that is substantially orthogonal to the first direction and includes a user causing a second set of items, corresponding to a different subset of the objects than the first set, to become viewable on the multi-touch screen using gestures corresponding to the first and second directions, where at least some of the gestures corresponding to the first direction are different than gestures corresponding to the second direction. The items may correspond to at least one attribute of at least some of the objects. Presenting a first subset of items may include showing icons, windows, markers, and/or shapes.

### CROSS-REFERENCE TO RELATED APPLICATIONS

This application claims priority to U.S. Prov. App. No. 61/897,908, filed Oct. 31, 2013, and entitled “NAVIGATING MULTIDIMENSIONAL OBJECT HIERARCHIES ON MULTI-TOUCH SCREENS”, which is incorporated herein by reference.

### TECHNICAL FIELD

This application is directed to the field of information management and presentation, especially in conjunction with navigating multi-aspect and hierarchical sets of objects on multi-touch screens.

### BACKGROUND OF THE INVENTION

In 2013, the number of connected mobile devices in use, including mobile phones and tablets, has exceeded the Earth's population. Market researchers forecast that by 2016 there will be over 10 billion Internet-connected mobile devices in the hands of end users, of which around eight billion will account for smartphones and tablets. Accordingly, everyday productivity and convenience of billions of people will be increasingly dependent on the efficiency of their use of mobile devices and applications.

Today, the majority of mobile devices are supplied with multi-touch screens. In addition, haptic control has long become a mainstream method of navigation and operation on smartphones and tablets. Several basic touch gestures, such as tap, drag/scroll, pinch/zoom, are familiar to hundreds of millions of users and are assigned similar core navigational and data manipulation functions across a broad variety of platforms, form factors, and devices. Recent releases of key mobile and desktop operating systems, such as Apple iOS and OS X, further diversified the gesture set by emphasizing swipe gestures and four or five finger pinch gestures.

The ability to control and operate applications and mobile tablet desktop views and navigate and edit documents by performing quick multi-touch gestures on a device screen has advanced and simplified productive work with mobile devices. Notwithstanding the progress, usability requirements for touch controlled systems may present software and hardware designers and engineers with challenging tasks. A prominent example is a trade-off between sizes of touch-aware elements of a User Interface (UI) and the productive usage of a screen real estate. On the one hand, sufficient sizes of touch operated UI elements (buttons, navigation panes, tabs, etc.) are desirable for easy operation by users with larger fingertips and speed up the work for all categories of users who spend less time targeting these elements during their work. On the other hand, productive utilization of an overall screen space in many mobile applications dictates minimizing the navigation related portion of the UI to increase the area available for viewing and processing of the productive content: text, images, tables, graphs, etc. Such design challenges are characteristic for early generations of multi-touch UIs and invite innovative design approaches.

Another challenge with multi-touch UIs has to do with the very navigational metaphor: while user base gets increasingly familiar with multi-touch gestures and the role of the gestures in mobile device control, the core metaphor for navigating desktop, file and application systems on mobile devices remains essentially unchanged, at least with respect to major components, systems and applications running on mobile devices. Examples of such discrepancy between new capabilities and existing solutions include:
Date/time pickers common in desktop and web applications. Whether designed in a calendar style or a wheel scroller style, in known implementations, neither method utilizes multi-touch gestures to significantly simplify and speed up access to date selection, with an exception of a compact zoomable date picker designed by Evernote Corporation of Redwood City, Calif.
File explorers on Android devices and Windows tablets and Dropbox application on iOS, which represents the closest analog of file system for iPads and iPhones. Neither makes a good use of multi-touch gestures and all adhere to an old navigational metaphor where level-by-level access is done via scrolling and tapping.
Backup systems where access to file and folder history is awkward and in many cases limited to file-by-file and folder-by-folder exploration, which requires user navigation to individual items via a file explorer like UI and subsequent access of individual history snapshots of the items.
Application stores on mobile devices function similarly to file explorers in terms of accessing applications in different categories.

User screens are two-dimensional surfaces and users are accustomed to navigating application windows in two orthogonal directions, horizontal and vertical; therefore, the most intuitive and fast navigational schemes may utilize one or both screen dimensions.

Accordingly, it is desirable to develop easy-to-use and efficient one and two-dimensional navigation and information access methods for multi-touch screens of mobile devices.

### SUMMARY OF THE INVENTION

According to the system described herein, accessing objects on a multi-touch screen includes presenting, on the multi-touch screen, a first set of items corresponding to a subset of the objects that is less than all of the objects, where the multi-touch screen has a first direction and has a second direction that is substantially orthogonal to the first direction and includes a user causing a second set of items, corresponding to a different subset of the objects than the first set, to become viewable on the multi-touch screen using gestures corresponding to the first and second directions, where at least some of the gestures corresponding to the first direction are different than gestures corresponding to the second direction. The items may correspond to at least one attribute of at least some of the objects. The attributes may include timelines, a list of physical locations, a list of logical locations, a list of folders, a set of adjacent tabs, a set of time zones, hierarchies of categories, labels, and rating scales. The items may correspond to at least two related attributes of at least some of the objects and where the user may navigate to select a first value for a first one of the attributes in the first direction and to select a second value for a second one of the attributes in the second direction and choices available for the second value may depend upon a choice made for the first value. A specific attribute may be chosen from a list of attributes using gestures in the first direction on the multi-touch screen and a value for the specific attribute may be chosen using gestures in the second direction on the multi-touch screen. The objects may include documents, portions of documents, images, media files, folders, applications, time stamps, locations, browser tabs, and/or drawings. Presenting a first subset of items may include showing icons, windows, markers, and/or shapes. The objects may be maintained in a hierarchy and the user may transition between items at different levels of the hierarchy using zoom gestures. The objects may be maintained in a hierarchy and the user may transition between items at different levels of the hierarchy using clicking gestures and a single click may traverse down into the hierarchy and a double click may traverse up in the hierarchy. Using gestures may include accessing a navigable scale to select values corresponding to at least one of the items. Accessing objects on a multi-touch screen may also include the user causing a desired one of the items of one of the items to align with a fixed selection marker and the user choosing a value for the desired one of the items while the desired one of the items remains aligned with the fixed selection marker on the multi-touch screen. The fixed selection marker may be a selection needle. The user causing a desired one of the items to align with a fixed selection marker may include the user scrolling at least some of the items and causing the scrolling to stop when the desired one of the items is aligned with the fixed selection marker. The objects may be maintained in a hierarchy and the user may transition to a lower level of the hierarchy by aligning an object with the fixed selection marker.

According further to the system described herein, accessing objects on a multi-touch screen includes presenting, on the multi-touch screen, a first set of items corresponding to a subset of the objects that is less than all of the objects, where the multi-touch screen has a first direction and has a second direction that is substantially orthogonal to the first direction and includes the user causing a second set of items, different than the first set, to become viewable on the multi-touch screen using gestures is the first and second directions, where there are at least two alternative independent sets of gestures for at least one of the directions. The items may correspond to at least one attribute of at least some of the objects. The attributes may include timelines, a list of physical locations, a list of logical locations, a list of folders, a set of adjacent tabs, a set of time zones, hierarchies of categories, labels, and rating scales. The items may correspond to at least two related attributes of at least some of the objects and where the user may navigate to select a first value for a first one of the attributes in the first direction and to select a second value for a second one of the attributes in the second direction and choices available for the second value may depend upon a choice made for the first value. A specific attribute may be chosen from a list of attributes using gestures in the first direction on the multi-touch screen and a value for the specific attribute may be chosen using gestures in the second direction on the multi-touch screen. The objects may include documents, portions of documents, images, media files, folders, applications, time stamps, locations, browser tabs, and/or drawings. Presenting a first subset of items may include showing icons, windows, markers, and/or shapes. The objects may be maintained in a hierarchy and the user may transition between items at different levels of the hierarchy using zoom gestures. The objects may be maintained in a hierarchy and the user may transition between items at different levels of the hierarchy using clicking gestures and a single click may traverse down into the hierarchy and a double click may traverse up in the hierarchy. Using gestures may include accessing a navigable scale to select values corresponding to at least one of the items. Accessing objects on a multi-touch screen may also include the user causing a desired one of the items of one of the items to align with a fixed selection marker and the user choosing a value for the desired one of the items while the desired one of the items remains aligned with the fixed selection marker on the multi-touch screen. The fixed selection marker may be a selection needle. The user causing a desired one of the items to align with a fixed selection marker may include the user scrolling at least some of the items and causing the scrolling to stop when the desired one of the items is aligned with the fixed selection marker. The objects may be maintained in a hierarchy and the user may transition to a lower level of the hierarchy by aligning an object with the fixed selection marker.

According further to the system described herein, a non-transitory computer readable storage medium contains software that accesses objects on a multi-touch screen. The software includes executable code that presents, on the multi-touch screen, a first set of items corresponding to a subset of the objects that is less than all of the objects, where the multi-touch screen has a first direction and has a second direction that is substantially orthogonal to the first direction and includes executable code that causes a second set of items, corresponding to a different subset of the objects than the first set, to become viewable on the multi-touch screen in response to a user using gestures corresponding to the first and second directions, where at least some of the gestures corresponding to the first direction are different than gestures corresponding to the second direction. The items may correspond to at least one attribute of at least some of the objects. The attributes may include timelines, a list of physical locations, a list of logical locations, a list of folders, a set of adjacent tabs, a set of time zones, hierarchies of categories, labels, and rating scales. The items may correspond to at least two related attributes of at least some of the objects and where the user may navigate to select a first value for a first one of the attributes in the first direction and to select a second value for a second one of the attributes in the second direction and choices available for the second value may depend upon a choice made for the first value. A specific attribute may be chosen from a list of attributes using gestures in the first direction on the multi-touch screen and a value for the specific attribute may be chosen using gestures in the second direction on the multi-touch screen. The objects may include documents, portions of documents, images, media files, folders, applications, time stamps, locations, browser tabs, and/or drawings. Executable code that presents a first subset of items may show icons, windows, markers, and/or shapes. The objects may be maintained in a hierarchy and the user may transition between items at different levels of the hierarchy using zoom gestures. The objects may be maintained in a hierarchy and the user may transition between items at different levels of the hierarchy using clicking gestures and a single click may traverse down into the hierarchy and a double click may traverse up in the hierarchy. Using gestures may include accessing a navigable scale to select values corresponding to at least one of the items. The software may also include executable code that chooses a value for the desired one of the items while the desired one of the items remains aligned with the fixed selection marker on the multi-touch screen in response to the user causing a desired one of the items of one of the items to align with a fixed selection marker. The fixed selection marker may be a selection needle. The user causing a desired one of the items to align with a fixed selection marker may include the user scrolling at least some of the items and causing the scrolling to stop when the desired one of the items is aligned with the fixed selection marker. The objects may be maintained in a hierarchy and the user may transition to a lower level of the hierarchy by aligning an object with the fixed selection marker.

According further to the system described herein, a non-transitory computer readable storage medium contains software that accesses objects on a multi-touch screen. The software includes executable code that presents, on the multi-touch screen, a first set of items corresponding to a subset of the objects that is less than all of the objects, where the multi-touch screen has a first direction and has a second direction that is substantially orthogonal to the first direction, and includes executable code that causes a second set of items, different than the first set, to become viewable on the multi-touch screen in response to the user using gestures is the first and second directions, where there are at least two alternative independent sets of gestures for at least one of the directions. The items may correspond to at least one attribute of at least some of the objects. The attributes may include timelines, a list of physical locations, a list of logical locations, a list of folders, a set of adjacent tabs, a set of time zones, hierarchies of categories, labels, and rating scales. The items may correspond to at least two related attributes of at least some of the objects and where the user may navigate to select a first value for a first one of the attributes in the first direction and to select a second value for a second one of the attributes in the second direction and choices available for the second value may depend upon a choice made for the first value. A specific attribute may be chosen from a list of attributes using gestures in the first direction on the multi-touch screen and a value for the specific attribute may be chosen using gestures in the second direction on the multi-touch screen. The objects may include documents, portions of documents, images, media files, folders, applications, time stamps, locations, browser tabs, and/or drawings. Executable code that presents a first subset of items may show icons, windows, markers, and/or shapes. The objects may be maintained in a hierarchy and the user may transition between items at different levels of the hierarchy using zoom gestures. The objects may be maintained in a hierarchy and the user may transition between items at different levels of the hierarchy using clicking gestures and a single click may traverse down into the hierarchy and a double click may traverse up in the hierarchy. Using gestures may include accessing a navigable scale to select values corresponding to at least one of the items. The software may also include executable code that chooses a value for the desired one of the items while the desired one of the items remains aligned with the fixed selection marker on the multi-touch screen in response to the user causing a desired one of the items of one of the items to align with a fixed selection marker. The fixed selection marker may be a selection needle. The user causing a desired one of the items to align with a fixed selection marker may include the user scrolling at least some of the items and causing the scrolling to stop when the desired one of the items is aligned with the fixed selection marker. The objects may be maintained in a hierarchy and the user may transition to a lower level of the hierarchy by aligning an object with the fixed selection marker.

The proposed system allows fast access to specific items in object collections on a mobile device screen via multi-touch navigation in a horizontal direction, vertical direction, or both directions where each direction may correspond to a different navigational aspect. Multi-touch gestures may be combined into navigational routines for accessing items; each gesture may be assigned to one or more significant one-dimensional navigational attributes of the collections and may alter attribute values or visible sets of items as users invoke navigational routines.

Object collections may include files (such as documents, images or media files), folders, applications, time stamps, locations, browser or other application tabs, portions of documents or drawings, etc. Objects may be visualized on a mobile device screen as icons, windows, markers, shapes and other items.

A significant feature of navigation is selecting an item or a group of items as part of providing access to the corresponding objects. To select an item, a user may perform the following steps:
Navigate an object collection to bring the item to the screen, typically within a scrollable item list.
Tap or touch a desired object with a finger or scroll an item list until the desired object appears against a fixed selection marker (such as a pin or a selection needle) or other on-screen substance.

In some implementations, stopping the scrolling process when a desired item or value appears at the marker position causes immediate selection of the item.

Attributes of object collections may include timelines; physical or logical locations visualized in various ways, such as a list of hardware drives and other memory devices, a list of folders or directories, a set of adjacent tabs, a set of time zones, etc. Attributes may also represent hierarchies of categories, labels, rating scales, etc. An attribute may be represented by a plain scrollable scale showing values of the attribute or by a hierarchical structure navigable on a device screen.

In some existing applications, a difference between the two navigational directions (horizontal or vertical relatively to the current screen position, such as portrait or landscape) may be ignored; for example, an orientation of a pinch gesture in iOS or Android applications on tablets or smartphones may be arbitrary—horizontal, vertical, diagonal—and may still yield the same resizing result, irrespective of the direction. In contrast, the proposed system may specifically distinguish between the two directions and may even assign different sets of gestures for operating along the horizontal and vertical axes, since such operations may apply to different attributes of object collections and to respective item lists of object collections or other scales. Accordingly, a navigational routine introduced elsewhere herein may include one or several multi-touch gestures assigned to basic navigational operations over a chosen attribute and applicable only to a certain orientation (horizontal or vertical) of an attribute scale. A user may perform the gestures included in the routine in a certain order to quickly access desirable items in object collections.

For example, a navigational routine for a hierarchical object collection visualized via vertically oriented scales or item lists may contain the following gesture set:
Two vertical scrolling gestures, namely, a one-finger scroll and one-finger swipe, for regular and fast scrolling in a vertical direction.
A one-finger single tap for item selection and a two-finger single tap for multiple object selection/un-selection. A two-finger tapping of an object adds the object to a selection if the object has not been selected and excludes the object from the selection if the object has already been selected.
A two-finger vertical pinch and reverse pinch (stretch) for zooming in and out an attribute hierarchy. Thus, a reverse pinch may move the object collection into a next hierarchy level, one level down the current state, while a regular pinch may return (or move) the collection one level up in the object hierarchy.

Obviously, a similar routine may apply to a horizontal direction just as well after transposing the direction of each direction-dependent gesture within the above navigational routine to the horizontal direction; the new gesture set may be used to navigate another attribute scale with a horizontal layout or the same scale rotated by 90 degrees. It should be noted that the notions of horizontal and vertical direction may be relative to a screen position (e.g. portrait vs. landscape) and may also depend on an application user interface where the attribute scale(s) may appear side-by-side with other UI elements.

An example of one-dimensional hierarchical multi-touch navigation is a standalone or an embedded date/time picker in a variety of mobile applications, as described in U.S. patent application Ser. No. 14/212,103 titled: “COMPACT ZOOMABLE DATE PICKER”, filed on Mar. 14, 2014 by Ma, et al. and incorporated by reference herein. Similar navigational routines may be built and applied to multi-touch routing of folders, lists of product categories in an application or a retail store, tables of contents of complex projects or books, etc. For simple non-hierarchical attributes, such as a list of time zones in a PC time settings panel or on a map of time zones, a list of product ratings or price ranges, and other basic attributes, navigational routines may be simplified; for example, a subset of gestures may exclude zoom in/out gestures designated for navigating through object hierarchies, as explained elsewhere herein.

A two-dimensional navigation of object collections may work as follows:
Object collections and routing processes of the object collections may be analyzed to choose two most important navigational aspects (attributes), provided that each of the attributes is represented as a one-dimensional navigable set with plain or hierarchical navigation.
For each of the two attributes, a navigable scale may be designed and a navigational direction for multi-touch direction-dependent gestures may be chosen (horizontal or vertical, depending on characteristics of the object collection and of each scale)
Navigational routines may be built for each scale, as explained elsewhere herein.

The two attribute axes may be displayed on the screen with tips on navigational routines the first time a user navigates the object collection (the tips may also be displayed on a user demand). The user may navigate one or both attributes in the corresponding directions to get to desired item(s) within object collections as fast as possible. In embodiments, several alternative pairs of attributes may be assigned to a complex object collection and may enable switching the pairs of attributes on the fly and choosing different pairs of attributes as a default setting.

Examples of high-profile applications with two-dimensional navigation of object collections may include:
Advanced file explorer for mobile devices with multi-touch screens where browsing a folder tree is continuous and does not require reaching needed higher level folders on the screen and tapping on each of the higher level folders to go to the next hierarchical level. The two navigational attributes may include (1) a folder tree, which may be navigated vertically, and (2) a plain navigation of files and sub-folders of the selected and opened folder performed horizontally. In an embodiment, making a vertical zoom in (reverse pinch) gesture on any folder item may open the folder and display its content. Using semi-transparency to display an outline of a next level content of a folder or other hierarchically scrollable item in a collection may help quickly convey the contents of a container prior to zooming in and save user efforts.
Navigating a backup or a revision system where one of the attributes is time and another attribute corresponds to browsing through files and folders representing a truncated version of the previous scheme. For example, making a vertical zoom in/out gesture on a selected item may open a custom vertical time scale for the item representing all time stamps for the item history, i.e. the moments when the content of the item was changed. The time scale may be browsed with further zooming in and out to find a needed version (revision) in the item history.
Navigating an application store or an online retail store where the first attribute and a corresponding browsing direction represent the list of categories, plain or hierarchical, while the second attribute and the orthogonal browsing direction show the list of items ordered, for example, by customer ratings or by time. In an embodiment, the second navigation direction may be inherently variable and may correspond to a sorting order by a certain attribute that a user may explicitly change on the fly.

Irrespective of a particular implementation, the proposed approach to navigating hierarchical systems takes advantage of user's spatial and muscle memory, introducing persistent movement procedures, analogously to user actions when locating an icon on a cluttered desktop, provided the icon stays in place.

### BRIEF DESCRIPTION OF THE DRAWINGS

Embodiments of the system described herein will now be explained in more detail in accordance with the figures of the drawings, which are briefly described as follows.

FIG. 1 is a schematic illustration of navigational multi-touch routines, according to an embodiment of to the system described herein.

FIG. 2 is a schematic illustration of a one-dimensional date and time attribute scale with a vertical hierarchical multi-touch navigation, according to an embodiment of the system described herein.

FIG. 3 is a schematic illustration of a two-dimensional hierarchical multi-touch navigation of an application store, according to an embodiment of the system described herein.

FIG. 4 is a system flow diagram describing functioning of a design phase of the system, according to an embodiment of the system described herein.

FIG. 5 is a system flow diagram describing functioning in connection with a navigational phase of the system, according to an embodiment of the system described herein.

### DETAILED DESCRIPTION OF VARIOUS EMBODIMENTS

The system described herein provides a mechanism for fast access to individual items and groups of items in object collections on a mobile device screen via multi-touch navigation in a horizontal, vertical or both directions. Multi-touch gestures may be combined into navigational routines for accessing items and each gesture may be assigned to one or more significant one-dimensional navigational attributes of the object collections and may alter attribute values or visible sets of items as users invoke such navigational routines.

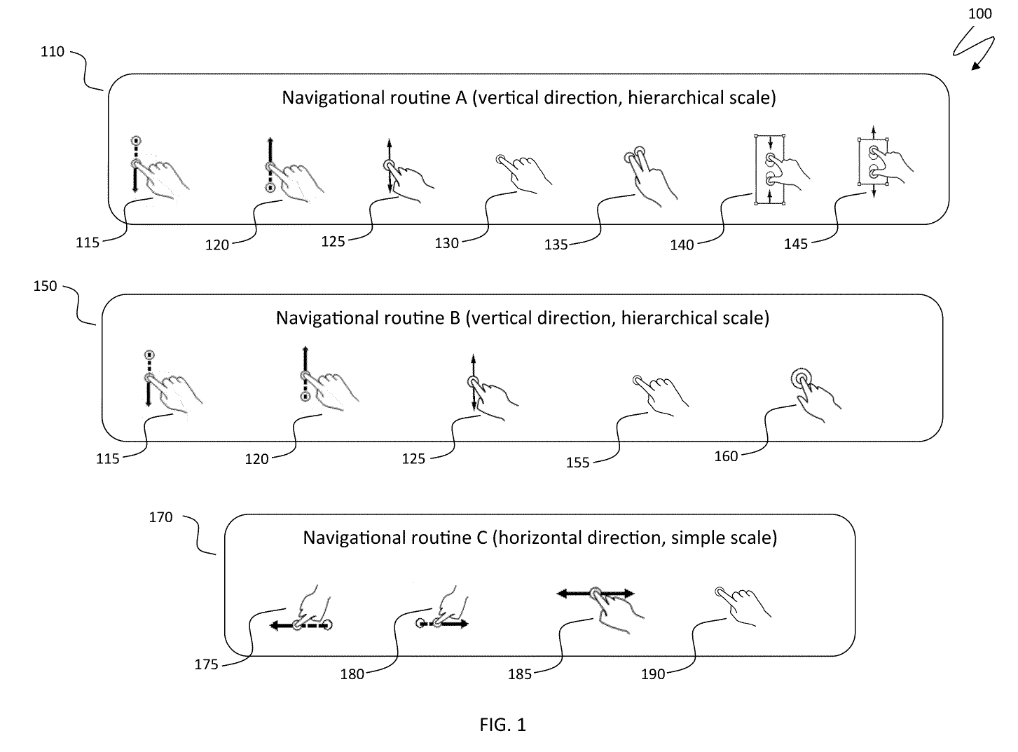

FIG. 1 is a schematic illustration 100 of navigational multi-touch routines. A navigational routine 110 provides a set of multi-touch gestures in a vertical direction and serves a hierarchical organization of object collections. One-finger swipe gestures, swipe down 115 and swipe up 120, allow fast scrolling with inertia of an object collection organized along a vertical navigational scale; examples may be date and/or time scales, explained elsewhere herein, a list of file details in a folder, a list of products in a chosen category in an online store, etc. Once a fast scrolling gesture moves an object list sufficiently close to desired objects so that the object(s) appear on the screen or are anticipated by the user to appear on the screen, a scrolling gesture 125 in a vertical direction (up or down) positions a desired object or a set of objects on the screen to allow the user further manipulation with the object(s). Examples of such manipulations may be a single or multiple object selection. A single object selection is enabled by a one-finger single tap gesture 130 (click), which selects a clicked object and automatically deselects it if another object is clicked. A multiple object selection is achieved through a two-finger single tap. Every time an object is tapped with two fingers, the selection status of the object is altered from an unselected to a selected state and vice versa, which allows easy creation of multiple selected objects (selected object sets). Selected objects may be visualized in various ways compatible with a design style of the object collection (highlighting, changing background of font properties, including color, etc.).

In order to enable navigation of an object collection hierarchy, the navigational multi-touch routine 110 employs two gestures: pinch 140 and reverse pinch 145 (stretch). The first of these gestures, pinch 140, resembles a closing move and may serve to move one level up in the hierarchy, while the gesture 145 resembles an opening move and may help a user dive one level down in the hierarchy. Thus, the gesture 145 may open a file folder or enter a product category to show details thereof—subcategories or specific products.

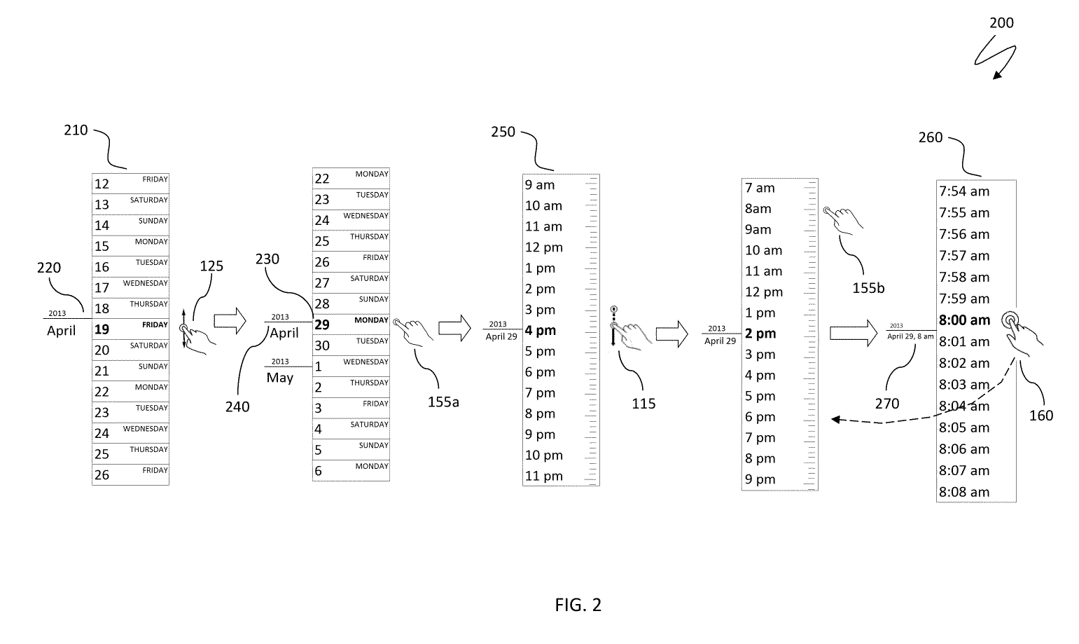

An alternative navigational routine 150 is designed for a similar navigational purpose as the routine 110, i.e. for navigating a hierarchical object collection, where object lists or scales are oriented in a vertical direction. The first three gestures of this routine: swipe down, swipe up and scroll up/down, repeat the gestures 115, 120, 125 explained in conjunction with the routine 110. A one-finger single tap gesture 155 may have the same haptic profile as the selection gesture 130 but is assigned a different functionality: in addition to selecting an object, the gesture 155 instantly moves an object collection to a next hierarchical level. A gesture 160 in the navigational routine 150 is a one-finger double tap that performs a converse function to the gesture 155: unselects an object to which the gesture 160 is applied and moves an object collection one level up in an object hierarchy. Both gestures 155, 160 are further explained in FIG. 2 in conjunction with a date and time picker and a corresponding object collection.

A third navigational routine 170 is designated for navigating a simple non-hierarchical horizontally oriented scale without a multiple selection capability. Efficient navigation may be based on four multi-touch gestures: horizontal swipe left 175, horizontal swipe right 180, horizontal scroll 185, and a one-finger click 190 for individual object selection. The gestures function similarly to analogs in the groups 110, with the transposition of gestures 115, 120, 125 from a vertical direction to a horizontal direction.

FIG. 2 is a schematic illustration 200 of a one-dimensional date and time attribute scale with a vertical hierarchical multi-touch navigation utilizing the navigation routine 150 in FIG. 1. Navigation starts with a date/weekday scale 210 which corresponds to a particular year/month setting 220 and may be automatically generated and displayed on a multi-touch screen of a mobile device by a software application, such as a calendar, a task management, a project management or another scheduling application making use of the date and time settings.

In the example of FIG. 2, a user scrolls the scale 210 using the scrolling gesture 125 explained in navigational routines of FIG. 1, in order to position a desired date 230 (29-Monday) at a selection needle 240. Positioning a date at the needle automatically selects the date, so a click 155a (the functioning of the click 155a is explained in conjunction with the navigational routine 150 in FIG. 1) near the date area confirms a previous selection and moves the navigation process one level down in an object hierarchy to the quarter-hour scale 250. Note that a selected date (April 29) may be displayed on the scale 250 around the selection needle 240. To select a desired time setting on the scale 250, the user may invoke fast scrolling via the swipe down gesture 115 explained elsewhere herein, in particular, in the navigational routine 150 in FIG. 1. Once a desired object (an Sam hour mark), initially invisible on a scale 260, comes into the user view, the user does not need to wait until the object moves down to coincide with the selection needle 240; neither does the user need to facilitate a scale movement using a slowed down regular scrolling gesture. Instead, the user may speed up the selection by clicking on the moving scale as indicated by a gesture 155b. In this case, the gesture 155b serves both designations: (a) the gesture 155b selects the needed object, the time stamp 8 am, which instantly jumps to a selection needle 270, and (b) the gesture 155b shifts the object collection one level down in the object hierarchy. The selected object is added to the date and time display around the selection needle 270 and an hour-and-minute scale 260 appears on the screen. In case the user wants to return back and change, as an example, an hour setting, making the one-finger double tap gesture 160 both unselects a previously selected value (8 am) and moves the object collection up one level to a previous quarter-hour scale.

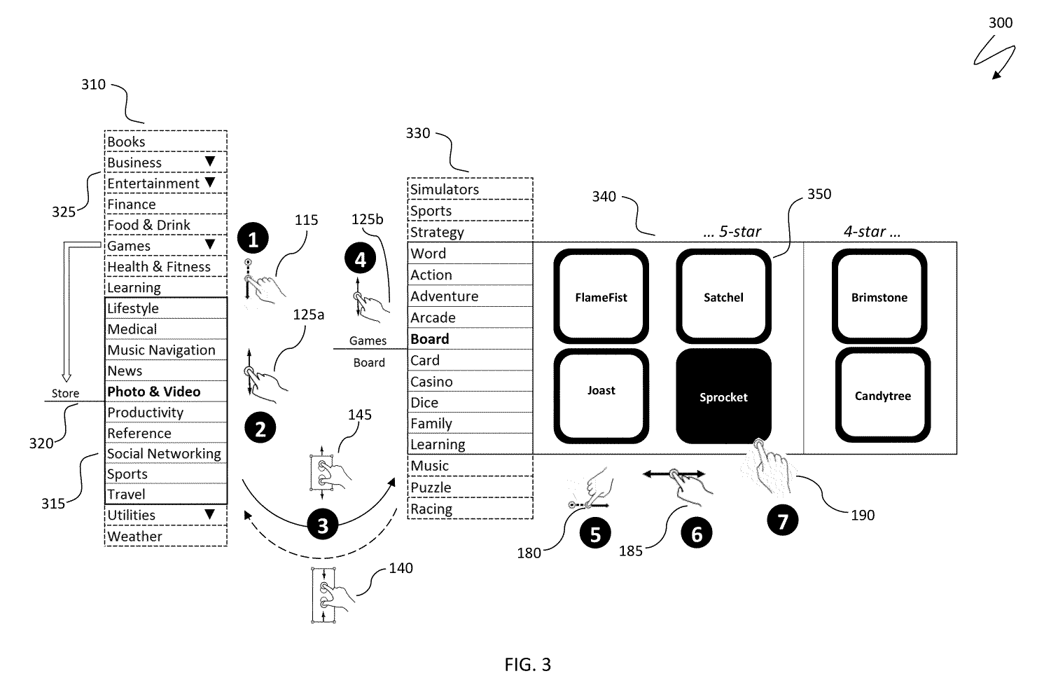

FIG. 3 is a schematic illustration 300 of a two-dimensional hierarchical multi-touch navigation of an application store. A two-dimensional navigation routine combines a vertical navigational routine 110 and a horizontal navigational routine 170, both explained in FIG. 1 and in the accompanying text. Navigation starts with a product category pane 310 of an application store. A visible part 315 (in a solid frame) of the pane 310 is displayed on the screen and a category appearing at a selection needle 320 is selected and highlighted by a bold font. At a step 1, a user swipes down a category list using the gesture 115, explained elsewhere herein, in order to quickly move a desired Games category into view of the user. Once the category appears on the screen, the user may switch to a step 2 of the navigation process and use a slower and better-controlled vertical scrolling gesture 125a to position the Games category at the selection needle.

Since the Games category has sub-categories, as indicated by a triangular mark in the category pane 310, the user may switch to a step 3 and perform the reverse pinch gesture 145 to move one level down in the hierarchy and gain access to sub-categories 330 of the selected category. In the event something goes wrong and the user needs to return to the full category list, the pinch gesture 140 brings the user back, one level up in the hierarchy, as shown by a dashed curved arrow. Navigating a sub-category pane 330 at a step 4 via a vertical scrolling gesture 125b, the user may select a needed sub-category of Board games by positioning the sub-category against the selection needle, which completes navigation across vertical scales in the object collection. A horizontal direction is represented by product panes 340 containing application icons 350, which may be ordered by user ratings or other parameters. In the example of FIG. 3, the sequence of horizontal product panes corresponds to decreasing user ratings and applications with the same rating are alphabetically ordered by names. The user may apply the horizontal swipe gesture 180 at a step 5 to quickly scroll through the product pane until an application of interest appears in view of the user, then adjust the navigation by the horizontal scroll 185 at a step 6, and finally select a needed application by the one-finger click 190 on the application icon at a final step 7.

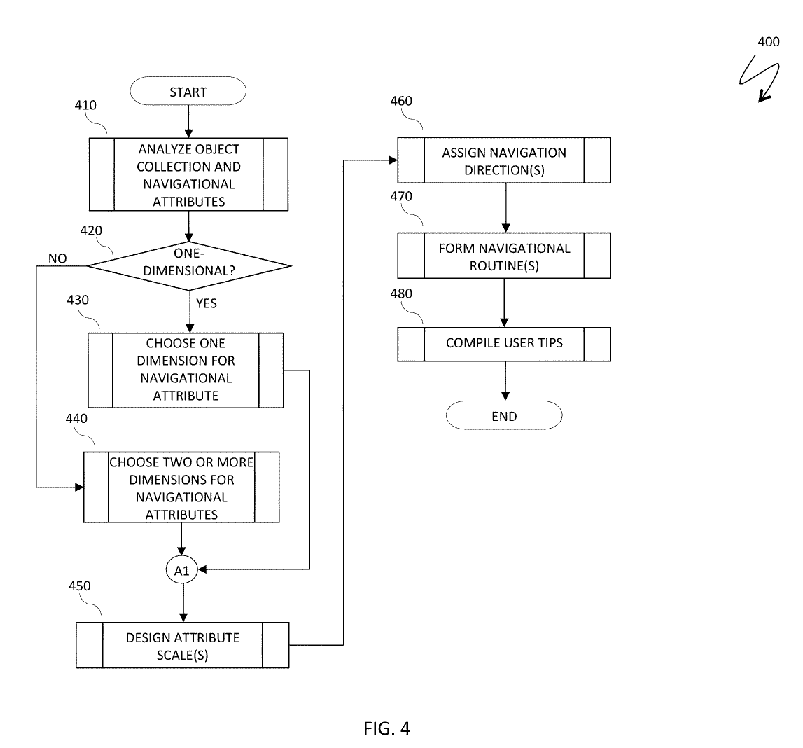

Referring to FIG. 4, a flow diagram 400 illustrates processing performed in connection with functioning of a design phase of the system described herein. Processing begins at a step 410 where an object collection and navigational attributes of the object collection required for efficient access to objects are analyzed. After the step 410, processing proceeds to a test step 420 where it is determined whether a one-dimensional navigation is sufficient to efficiently access objects in the collection. If so, processing proceeds to a step 430 where a navigational attribute is chosen. Examples may include folder list, date and time scales (see FIG. 2), etc.

After the step 430, processing proceeds to a step 450. If it is determined at the test step 420 that a one-dimensional navigation does not serve the purpose of efficient access to objects, processing proceeds to a step 440 where two (or more) navigational attributes implemented in different screen dimensions are chosen. One example of such navigation is an application store illustrated in FIG. 3. After the step 440, processing proceeds to the step 450, which may be independently reached from the step 430. At the step 450, attribute scales for each navigational dimension are designed; in particular, for each navigational attribute a decision is made whether it is a plain or a hierarchical attribute. Scale design includes an attribute layout (object scale, item list, etc.), a designation of navigable units displayed on each scale or in each list, and formatting the units. After the step 450, processing proceeds to a step 460 where a navigational direction is assigned to a single attribute or to each of the two or more attributes. Choosing navigational direction may be relative to a device screen rotation (for example, portrait/landscape for a device screen and horizontal/vertical for a navigational direction); choosing a navigation direction also includes final formatting and arranging of navigable units on each attribute scale (in each list). After the step 460, processing proceeds to a step 470 where navigational routines are formed, i.e. a sequence of multi-touch gestures is assigned to each navigational attribute, allowing scrolling, panning, altering hierarchy levels (where applicable), individual and possibly multiple object selection, etc. Examples of navigational routines are presented in FIG. 1 and further explained in FIGS. 2, 3 and the accompanying texts. After the step 470, processing proceeds to a step 480 where user tips displayed at a first use of each navigational gesture and routine or on user demand are compiled and incorporated with the system design. After the step 480, processing is complete.

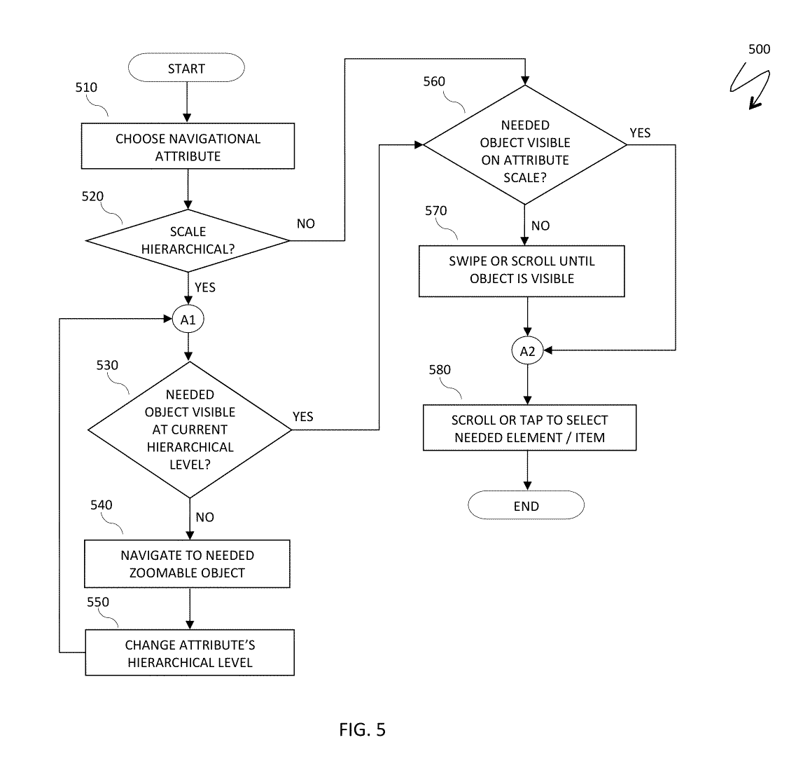

Referring to FIG. 5, a flow diagram 500 illustrates processing performed in connection with functioning of a navigational phase of the system described herein. Processing begins at a step 510 where a user chooses a navigational attribute previously designed (as explained in FIG. 4) and assigned to accessing objects in an object collection. After the step 510, processing proceeds to a test step 520 where it is determined whether the chosen attribute possesses a hierarchical scale (a list of items or other attribute representation). If so, processing proceeds to a test step 530 where it is determined whether an object (or a set of objects) the user desired to access is visible at a current zoom level. For example, in FIG. 2 the user may need to select a meeting time in hours; if the currently visible scale displays quarter-hours, the user may utilize it; but if the scale shows month days and the corresponding weekdays, the user has to change the hierarchical level.

If it is determined at the step 520 that the chosen attribute does not possess a hierarchical scale, processing proceeds to a step 540 where a user navigates to a needed zoomable object (such as a date in FIG. 2, a product category in an application store in FIG. 3, a folder in a file system, etc.). The term “zoomable” may include instances where the object may have an assigned additional level of hierarchy (such as in case of a folder in a file system, a category with sub-categories or a menu item with a sub-menu) or that selecting an object is a pre-condition to switching to a new hierarchical level (as in case of date and time settings in FIG. 2). The user may utilize any of the assigned navigational gestures for the current attribute to get to the zoomable object, such as swiping for fast scrolling, regular scrolling, etc. Sometimes, navigation may not be necessary, such as in a situation when a user needs to change a hierarchical view of an object collection to fix an error and hence does not need to keep the navigation consistent with the current object choice (examples are the gesture 160 in FIG. 2 or the gesture 140 in FIG. 3).

After the step 540, processing proceeds to a step 550 where the user changes a hierarchical level of an attribute using one of the assigned multi-touch gestures within a navigational routine. The gesture may simultaneously select the zoomable object, explained elsewhere herein, such as the one-finger click 155, to select an object and change a hierarchical level in a navigational routine 150 in FIG. 1. Alternatively, an object may be selected by positioning the object near a selection marker, such as the selection needle in FIGS. 2, 3 or by a standalone click-selection gesture, such as the gesture 130 in the navigational routine 110; after such selection, a change of a hierarchical level of an object collection may be achieved by making a separate gesture, such as the pinch or reverse pinch gestures 140, 145 in the navigational routine 110.

After the step 550, processing proceeds to a test step 560 where it is determined whether a needed object, a set of objects or a portion of such set (for example, a subset of objects designated for a multiple selection action) are visible on the current attribute scale. Note that the step 560 may be independently reached from the test step 520 if it was determined that the attribute scale or other layout is non-hierarchical and from the test step 530 if the needed object was visible on the then current scale and therefore didn't require a change in the object hierarchy. If a needed object, a set of objects or a portion of such set are not visible on the current attribute scale then processing proceeds to a step 570 where the user navigates (for example, swipes or scrolls, as explained elsewhere herein) the current attribute scale, list or other layout to bring a desired object or at least a portion of an object set into the user view, so the objects are visible on the device screen. After the step 570, processing proceeds to a step 580 where the user scrolls or taps to select the needed object or add/delete it to/from a multiple selection object set. The step 580 may be independently reached from the test step 560 if the needed object or at least a portion of an object set were already visible on the current scale or list. After the step 580, processing is complete.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions. The system described herein may be implemented on a mobile device. The mobile device may be a cell phone or a tablet, although other devices, such as a laptop or desktop computer with a touch enabled screen, are also possible. The mobile device may include software that is pre-loaded with the device, installed from an app store, installed from a desktop (after possibly being pre-loaded thereon), installed from media such as a CD, DVD, etc., and/or downloaded from a Web site. The mobile device may use an operating system selected from the group consisting of: iOS, Android OS, Windows Phone OS, Blackberry OS and mobile versions of Linux OS.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system. The items in object collections may be stored using a file system of the OS X operating system or an App Store provided by Apple, Inc., a file system provided by the Windows® operating system or the OneNote® note-taking software provided by the Microsoft Corporation of Redmond, Wash. or a file system of the Linux operating system distributions provided by multiple vendors.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of accessing objects on a multi-touch screen, comprising:
presenting, on the multi-touch screen, a first set of items corresponding to a subset of the objects that is less than all of the objects, wherein the multi-touch screen has a first direction and has a second direction that is substantially orthogonal to the first direction; and
a user causing a second set of items, corresponding to a different subset of the objects than the first set, to become viewable on the multi-touch screen using gestures corresponding to the first and second directions, wherein at least some of the gestures corresponding to the first direction are different than gestures corresponding to the second direction.

2. The method, according to claim 1, wherein the items correspond to at least one attribute of at least some of the objects.

3. The method, according to claim 2, wherein the attributes include timelines, a list of physical locations, a list of logical locations, a list of folders, a set of adjacent tabs, a set of time zones, hierarchies of categories, labels, and rating scales.

4. The method, according to claim 3, wherein the items correspond to at least two related attributes of at least some of the objects and wherein the user navigates to select a first value for a first one of the attributes in the first direction and to select a second value for a second one of the attributes in the second direction and wherein choices available for the second value depend upon a choice made for the first value.

5. The method, according to claim 3, wherein a specific attribute is chosen from a list of attributes using gestures in the first direction on the multi-touch screen and a value for the specific attribute is chosen using gestures in the second direction on the multi-touch screen.

6. The method, according to claim 1, wherein the objects include at least one of: documents, portions of documents, images, media files, folders, applications, time stamps, locations, browser tabs, and drawings.

7. The method, according to claim 1, wherein presenting a first subset of items includes showing at least one of: icons, windows, markers, and shapes.

8. The method, according to claim 1, wherein the objects are maintained in a hierarchy and wherein the user transitions between items at different levels of the hierarchy using zoom gestures.

9. The method, according to claim 1, wherein the objects are maintained in a hierarchy and wherein the user transitions between items at different levels of the hierarchy using clicking gestures and wherein a single click traverses down into the hierarchy and a double click traverses up in the hierarchy.

10. The method, according to claim 1, wherein using gestures includes accessing a navigable scale to select values corresponding to at least one of the items.

11. The method, according to claim 1, further comprising:
the user causing a desired one of the items of one of the items to align with a fixed selection marker; and
the user choosing a value for the desired one of the items while the desired one of the items remains aligned with the fixed selection marker on the multi-touch screen.

12. The method, according to claim 11, wherein the fixed selection marker is a selection needle.

13. The method, according to claim 11, wherein the user causing a desired one of the items to align with a fixed selection marker includes the user scrolling at least some of the items and causing the scrolling to stop when the desired one of the items is aligned with the fixed selection marker.

14. The method, according to claim 11, wherein the objects are maintained in a hierarchy and wherein the user transitions to a lower level of the hierarchy by aligning an object with the fixed selection marker.

15. A method of accessing objects on a multi-touch screen, comprising:
presenting, on the multi-touch screen, a first set of items corresponding to a subset of the objects that is less than all of the objects, wherein the multi-touch screen has a first direction and has a second direction that is substantially orthogonal to the first direction; and
the user causing a second set of items, different than the first set, to become viewable on the multi-touch screen using gestures is the first and second directions, wherein there are at least two alternative independent sets of gestures for at least one of the directions.

16. The method, according to claim 15, wherein the items correspond to at least one attribute of at least some of the objects.

17. The method, according to claim 16, wherein the attributes include timelines, a list of physical locations, a list of logical locations, a list of folders, a set of adjacent tabs, a set of time zones, hierarchies of categories, labels, and rating scales.

18. The method, according to claim 17, wherein the items correspond to at least two related attributes of at least some of the objects and wherein the user navigates to select a first value for a first one of the attributes in the first direction and to select a second value for a second one of the attributes in the second direction and wherein choices available for the second value depend upon a choice made for the first value.

19. The method, according to claim 17, wherein a specific attribute is chosen from a list of attributes using gestures in the first direction on the multi-touch screen and a value for the specific attribute is chosen using gestures in the second direction on the multi-touch screen.

20. The method, according to claim 15, wherein the objects include at least one of: documents, portions of documents, images, media files, folders, applications, time stamps, locations, browser tabs, and drawings.

21. The method, according to claim 15, wherein presenting a first subset of items includes showing at least one of: icons, windows, markers, and shapes.

22. The method, according to claim 15, wherein the objects are maintained in a hierarchy and wherein the user transitions between items at different levels of the hierarchy using zoom gestures.

23. The method, according to claim 15, wherein the objects are maintained in a hierarchy and wherein the user transitions between items at different levels of the hierarchy using clicking gestures and wherein a single click traverses down into the hierarchy and a double click traverses up in the hierarchy.

24. The method, according to claim 15, wherein using gestures includes accessing a navigable scale to select values corresponding to at least one of the items.

25. The method, according to claim 15, further comprising:
the user causing a desired one of the items of one of the items to align with a fixed selection marker; and
the user choosing a value for the desired one of the items while the desired one of the items remains aligned with the fixed selection marker on the multi-touch screen.

26. The method, according to claim 25, wherein the fixed selection marker is a selection needle.

27. The method, according to claim 25, wherein the user causing a desired one of the items to align with a fixed selection marker includes the user scrolling at least some of the items and causing the scrolling to stop when the desired one of the items is aligned with the fixed selection marker.

28. The method, according to claim 25, wherein the objects are maintained in a hierarchy and wherein the user transitions to a lower level of the hierarchy by aligning an object with the fixed selection marker.

29. A non-transitory computer readable storage medium containing software that accesses objects on a multi-touch screen, the software comprising:
executable code that presents, on the multi-touch screen, a first set of items corresponding to a subset of the objects that is less than all of the objects, wherein the multi-touch screen has a first direction and has a second direction that is substantially orthogonal to the first direction; and
executable code that causes a second set of items, corresponding to a different subset of the objects than the first set, to become viewable on the multi-touch screen in response to a user using gestures corresponding to the first and second directions, wherein at least some of the gestures corresponding to the first direction are different than gestures corresponding to the second direction.

30. The non-transitory computer readable storage medium, according to claim 29, wherein the items correspond to at least one attribute of at least some of the objects.

31. The non-transitory computer readable storage medium, according to claim 30, wherein the attributes include timelines, a list of physical locations, a list of logical locations, a list of folders, a set of adjacent tabs, a set of time zones, hierarchies of categories, labels, and rating scales.

32. The non-transitory computer readable storage medium, according to claim 31, wherein the items correspond to at least two related attributes of at least some of the objects and wherein the user navigates to select a first value for a first one of the attributes in the first direction and to select a second value for a second one of the attributes in the second direction and wherein choices available for the second value depend upon a choice made for the first value.

33. The non-transitory computer readable storage medium, according to claim 31, wherein a specific attribute is chosen from a list of attributes using gestures in the first direction on the multi-touch screen and a value for the specific attribute is chosen using gestures in the second direction on the multi-touch screen.

34. The non-transitory computer readable storage medium, according to claim 29, wherein the objects include at least one of: documents, portions of documents, images, media files, folders, applications, time stamps, locations, browser tabs, and drawings.

35. The non-transitory computer readable storage medium, according to claim 29, wherein executable code that presents a first subset of items shows at least one of: icons, windows, markers, and shapes.

36. The non-transitory computer readable storage medium, according to claim 29, wherein the objects are maintained in a hierarchy and wherein the user transitions between items at different levels of the hierarchy using zoom gestures.

37. The non-transitory computer readable storage medium, according to claim 29, wherein the objects are maintained in a hierarchy and wherein the user transitions between items at different levels of the hierarchy using clicking gestures and wherein a single click traverses down into the hierarchy and a double click traverses up in the hierarchy.

38. The non-transitory computer readable storage medium, according to claim 29, wherein using gestures includes accessing a navigable scale to select values corresponding to at least one of the items.

39. The non-transitory computer readable storage medium, according to claim 29, the software further comprising:
executable code that chooses a value for the desired one of the items while the desired one of the items remains aligned with the fixed selection marker on the multi-touch screen in response to the user causing a desired one of the items of one of the items to align with a fixed selection marker.

40. The non-transitory computer readable storage medium, according to claim 39, wherein the fixed selection marker is a selection needle.

41. The non-transitory computer readable storage medium, according to claim 39, wherein the user causing a desired one of the items to align with a fixed selection marker includes the user scrolling at least some of the items and causing the scrolling to stop when the desired one of the items is aligned with the fixed selection marker.

42. The non-transitory computer readable storage medium, according to claim 39, wherein the objects are maintained in a hierarchy and wherein the user transitions to a lower level of the hierarchy by aligning an object with the fixed selection marker.

43. A non-transitory computer readable storage medium containing software that accesses objects on a multi-touch screen, the software comprising:
executable code that presents, on the multi-touch screen, a first set of items corresponding to a subset of the objects that is less than all of the objects, wherein the multi-touch screen has a first direction and has a second direction that is substantially orthogonal to the first direction; and
executable code that causes a second set of items, different than the first set, to become viewable on the multi-touch screen in response to the user using gestures is the first and second directions, wherein there are at least two alternative independent sets of gestures for at least one of the directions.

44. The non-transitory computer readable storage medium, according to claim 43, wherein the items correspond to at least one attribute of at least some of the objects.

45. The non-transitory computer readable storage medium, according to claim 44, wherein the attributes include timelines, a list of physical locations, a list of logical locations, a list of folders, a set of adjacent tabs, a set of time zones, hierarchies of categories, labels, and rating scales.

46. The non-transitory computer readable storage medium, according to claim 45, wherein the items correspond to at least two related attributes of at least some of the objects and wherein the user navigates to select a first value for a first one of the attributes in the first direction and to select a second value for a second one of the attributes in the second direction and wherein choices available for the second value depend upon a choice made for the first value.

47. The non-transitory computer readable storage medium, according to claim 45, wherein a specific attribute is chosen from a list of attributes using gestures in the first direction on the multi-touch screen and a value for the specific attribute is chosen using gestures in the second direction on the multi-touch screen.

48. The non-transitory computer readable storage medium, according to claim 43, wherein the objects include at least one of: documents, portions of documents, images, media files, folders, applications, time stamps, locations, browser tabs, and drawings.

49. The non-transitory computer readable storage medium, according to claim 43, wherein executable code that presents a first subset of items shows at least one of: icons, windows, markers, and shapes.

50. The non-transitory computer readable storage medium, according to claim 43, wherein the objects are maintained in a hierarchy and wherein the user transitions between items at different levels of the hierarchy using zoom gestures.

51. The non-transitory computer readable storage medium, according to claim 43, wherein the objects are maintained in a hierarchy and wherein the user transitions between items at different levels of the hierarchy using clicking gestures and wherein a single click traverses down into the hierarchy and a double click traverses up in the hierarchy.

52. The non-transitory computer readable storage medium, according to claim 43, wherein using gestures includes accessing a navigable scale to select values corresponding to at least one of the items.

53. The non-transitory computer readable storage medium, according to claim 43, the software further comprising:
executable code that chooses a value for the desired one of the items while the desired one of the items remains aligned with the fixed selection marker on the multi-touch screen in response to the user causing a desired one of the items of one of the items to align with a fixed selection marker.

54. The non-transitory computer readable storage medium, according to claim 53, wherein the fixed selection marker is a selection needle.

55. The non-transitory computer readable storage medium, according to claim 53, wherein the user causing a desired one of the items to align with a fixed selection marker includes the user scrolling at least some of the items and causing the scrolling to stop when the desired one of the items is aligned with the fixed selection marker.

56. The non-transitory computer readable storage medium, according to claim 53, wherein the objects are maintained in a hierarchy and wherein the user transitions to a lower level of the hierarchy by aligning an object with the fixed selection marker.
